(19) United States
(12) Patent Application Publication
(10) Pub. No.: US 2016/0166365 A1
(43) Pub. Date: Jun. 16, 2016

(54) Toothbrush Flosser

(71) Applicant: Lila Ninh, Westminster, CA (US)

(72) Inventor: Lila Ninh, Westminster, CA (US)

(21) Appl. No.: 14/572,308

(22) Filed: Dec. 16, 2014

(51) Int. Cl. A61C 15/04; A46B 15/00

(52) U.S. Cl. CPC A61C 15/048; A46B 15/0055; A46B 2200/1066

(57) ABSTRACT

A toothbrush flosser has a handle having a pair of ends, namely a flossing head end and a brush head end. A toothbrush head is mounted to the brush head end, and the toothbrush head includes bristles. A flossing head retainer is mounted on the flossing head end. A flossing head is retained to the flossing head retainer at a connection area formed on the flossing head. The flossing head has a pair of arms that hold a floss in an extended position. The toothbrush flosser optionally includes a flossing head retainer groove formed on the connection area. The flossing head retainer groove has an inside sidewall, an outside sidewall opposing the inside sidewall; and a lower wall.

### FIELD OF THE INVENTION

The present invention is in the field of toothbrush flossers.

### DISCUSSION OF RELATED ART

A variety of different flossers have been made in the prior art. For example Monson in U.S. Pat. No. 893,345 issued Jul. 14, 1908, entitled Floss Holder Attachment For Toothbrushes, the disclosure of which is incorporated herein by reference, describes a toothbrush and flossing combination for dental hygiene. Monson provides a reloadable floss holder at an end of a toothbrush handle. Bennett in U.S. Pat. No. 5,483,902 issued Jan. 16, 1996 entitled Dental Floss Device provides for a dental floss device having a removable headpiece mounted on a handle, the disclosure of which is incorporated by reference. Bennett discloses a pair of snap fit projections that engage edges of the floor of the groove located on the headpiece of the handle.

A variety of different multifunctional devices have provided flossing and brushing. Ming and Meijuan in U.S. Pat. No. 6,886,570 issued May 3, 2005 and entitled Hybrid Dental Flosser and Toothbrush, provides for a dental floss device having an automatic flosser attached to an automatic toothbrush, the disclosure of which is incorporated by reference. The invention is a hybrid design of both an automatic toothbrush and dental flosser, where the dental floss automatically vibrates from side to side. U.S. Pat. No. 4,880,382 issued to Michel A. Moret, and Pierre J. Jousson on Nov. 14, 1989 entitled Integrated Oral Hygiene System, describes an automatic toothbrush with replaceable accessories system, the disclosure of which is incorporated by reference. Moret and Jousson provides an automatic toothbrush with replaceable heads of a brush, floss holder, and a gum stimulator. Zebuhr in U.S. Pat. No. 5,762,078 issued Jun. 9, 1998 and entitled Flosser Head for a Tooth Brush Driver, provides for a flosser head detachable to an automatic toothbrush, the disclosure of which is incorporated by reference. Zebuhr provides a power operated driver that is interchangeable with a toothbrush or flosser head.

U.S. Pat. No. 7,311,108, issued Dec. 25, 2007 entitled Motorized Flosser and Method of Use, describes a hybrid instrument for flossing and brushing teeth, the disclosure of which is incorporated by reference. The invention is comprised of a lengthened body mounting a flossing head of which has attached toothbrush bristles. Gross and Zucker in U.S. Pat. No. 5,033,150, issued Jul. 23, 1991 and entitled Motor Driven Toothbrush, provides for a motor driven toothbrush having a handle and removable toothbrush head, the disclosure of which is incorporated by reference. Gross and Zucker provide an oscillating handle extended to the detachable brush head or floss holder. In U.S. Pat. No. 5,483,982 entitled Dental floss device issued on Jan. 16, 1996, the disclosure of which is incorporated herein by reference, describes the basic idea of a mounted flosser head. The patent describes a head piece comprised of two jaws with dental floss in between and the base portion, comprised of a disposable dental floss holder, attached to a handle. U.S. Pat. No. 7,059,334 issued to Dougan on Jun. 13, 2006, on Jun. 13, 2006 entitled Dental Floss Device describes a basic disposable dental floss device, the disclosure of which is incorporated by reference. The floss device has a holder that can only be inter-engaged when both the holder and disposable head piece are properly aligned.

Ochs in U.S. Pat. No. 7,171,971, issued on Feb. 6, 2007 entitled Dental Floss Device With A Stackable Dental Floss Holder, provides for a dental floss device with a stackable dental floss holder that has a variety of different protrusions and indentations for attaching a dental floss holder to a handle, the disclosure of which is incorporated by reference. Ochs describes a handle as having a U-shape channel having a pair of spaced walls in which both the first and second wall are comprised of at least a one protrusion space and a single indentation. Also, Ochs in U.S. Pat. No. 7,174,904, entitled Dental Floss Device With A Stackable Dental Floss Holder issued on Feb. 13, 2007, provides for other various varieties of different protrusions and indentations for attaching dental floss holder to handle, the disclosure of which is incorporated by reference. The Ochs flosser is comprised of a base portion made up of a first and second lateral side. Each of these lateral side includes at least on protrusion and at least one indentation, spaced parallel to each other. Ochs in U.S. Pat. No. 7,325,554, issued on Feb. 5, 2008 entitled Dental Device With Improved Retention Of A Flavor And/Or Chemotherapeutic Agent Composition, also provides that a dental floss holder can have flavor and/or chemotherapeutic agents.

### SUMMARY OF THE INVENTION

A toothbrush flosser has a handle having a pair of ends, namely a flossing head end and a brush head end. A toothbrush head is mounted to the brush head end, and the toothbrush head includes bristles. A flossing head retainer is mounted on the flossing head end. A flossing head is retained to the flossing head retainer at a connection area on the flossing head. The flossing head has a pair of arms that hold a floss in an extended position. The toothbrush flosser optionally includes a flossing head retainer groove formed to receive the connection area of a flossing head. The flossing head retainer groove has an inside sidewall, an outside sidewall opposing the inside sidewall; and a lower wall.

Preferably, the toothbrush flosser flossing head retainer groove has a wider portion that forms a socket. The socket has a reversible engagement with the flossing head. The flossing head retainer groove preferably includes a retaining flange. The retaining flange may have a first retaining flange section and a second retaining flange section that overhang the retainer groove at a groove overhang. The flossing head retainer groove can be formed on the flossing head retainer. The flossing head retainer groove can include an inside sidewall, an outside sidewall opposing the inside sidewall, and a lower wall.

The flossing head retainer groove preferably has a wider portion that forms a socket. The pair of arms of the flossing head can have an engaging means that includes a first flossing head arm having a first retaining arm notch and second flossing head arm having a second retaining arm notch. The first retaining arm notch may have an inward orientation so that it is opposing the second retaining arm notch, and the second retaining arm notch may have an inward orientation so that it is opposing the first retaining arm notch. The first retaining arm notch and the second retaining arm notch are both configured to engage the flossing head retainer.

### BRIEF DESCRIPTION OF THE DRAWINGS

FIG. 1 is a front perspective view of a flossing head.

FIG. 2 is a rear perspective view of a flossing head.

FIG. 3 is a side perspective view of a flossing head.

FIG. 4 is an exploded perspective view of a toothbrush flossing handle showing the first position of the flossing head.

FIG. 5 is an exploded perspective view of a toothbrush flossing handle showing the second position of the flossing head.

FIG. 6 is a side view of a brush flossing handle.

FIG. 7 is a rear exploded perspective view of a toothbrush flossing handle.

FIG. 8 is a front perspective view of a flossing head.

FIG. 9 is a rear perspective view of a flossing head.

FIG. 10 is a rear perspective view of a flossing head.

FIG. 11 is a detail exploded perspective view of a flossing head connecting to a toothbrush flossing handle showing the first position of the flossing head.

FIG. 12 is a detail exploded perspective view of a flossing head connecting to a toothbrush flossing handle showing the second position of the flossing head.

The following call out list of elements can be a useful guide referencing the elements of the drawings.
20 Flossing Head
21 Floss
22 First Flossing Connection
23 Second Flossing Connection
24 First Retaining Arm Connection
25 Second Retaining Arm Connection
26 First Retaining Arm
27 Second Retaining Arm
28 First Retaining Arm Protrusion
29 Second Retaining Arm Protrusion
30 Connection Area
31 First Retaining Arm Notch
32 Second Retaining Arm Notch
33 First Flossing Head Indentation
34 Second Flossing Head Indentation
35 Flossing Head Handle
36 Brush Head Handle
37 Handle Junction
38 Bristles
39 Flossing Head Grip
40 Flossing Head Retainer
41 Flossing Head Retainer Groove
42 First Retaining Flange
43 Second Retaining Flange
44 Groove First Indentation
45 Groove Second Indentation
46 Groove Overhang
47 Inside Sidewall
48 Outside Sidewall
49 Lower Wall
51 First Flossing Head Protrusion
52 Second Flossing Head Protrusion
53 Flexible Opening

### DETAILED DESCRIPTION OF THE PREFERRED EMBODIMENT

The toothbrush flosser has a flossing head 20 having a connection area 30 that engages and removably mounts to a flossing head retainer 40. The flossing head retainer 40 is connected to a flossing head handle 35, which is in turn connected to a brush head handle 36 having a brush with bristles 38. The flossing head 20 is preferably a disposable member that is detachable and attachable to the flossing head retainer 40. The flossing head 20 preferably has a snap-on and snap off engagement with the connection area 30 of the flossing head engaging the flossing head retainer 40.

The flossing head generally has floss 21 having a pair of ends, namely a first flossing connection 22 and a second flossing connection 23. The first flossing connection 22 is connected to the first retaining arm connection 24 on the first retaining arm 26. The second flossing connection 23 is connected to the second retaining arm connection 25 on the second retaining arm 27. The first retaining arm 26 and second retaining arm 27 join to each other at a bridge that is forms a connection area 30. The flossing head has a first retaining arm and a second retaining arm joined at a bridge.

The first retaining arm has a first retaining arm protrusion 28 and a second retaining arm protrusion 29 that form a first retaining arm notch 31 and a second retaining arm notch 32. The first flossing head indentation 33 can form a gap with the groove first indentation 44, and the second flossing head indentation 34 can form a gap with the groove second indentation 45. The first retaining arm and the second retaining arm are preferably made of resilient plastic to provide a tension to the floss 21, also called flossing line that is used to engage areas of the teeth for ease in flossing.

The flossing head grip 39 can be formed on the flossing head handle 35, which is joined to the brush head handle 36 at a handle junction 37. The flossing head grip can be plastic injection molded with a two-step process where the first injection is a rigid plastic that provides a frame for the flossing head handle, and where the second injection provides a soft silicone plastic grip.

The flossing head has a flossing head retainer groove 41 with a first retaining flange 42 and a second retaining flange 43 that create a groove overhang 46 for retaining the flossing head 20. The groove overhang 46 and flossing head retainer groove 41 can be resiliently deformable to release the flossing head 20 when a preset pressure is applied.

A first flossing head protrusion 51 and a second flossing head protrusion 52 can have a flexible opening 53 between them shaped as an oval shaped opening that allows flexing of the first flossing head protrusion 51 and a second flossing head protrusion 52 to bias outwardly against the groove first indentation 44 and groove second indentation 45. The groove first indentation 44 and groove second indentation 45 can resiliently secure to the flossing head protrusions for snap fit.

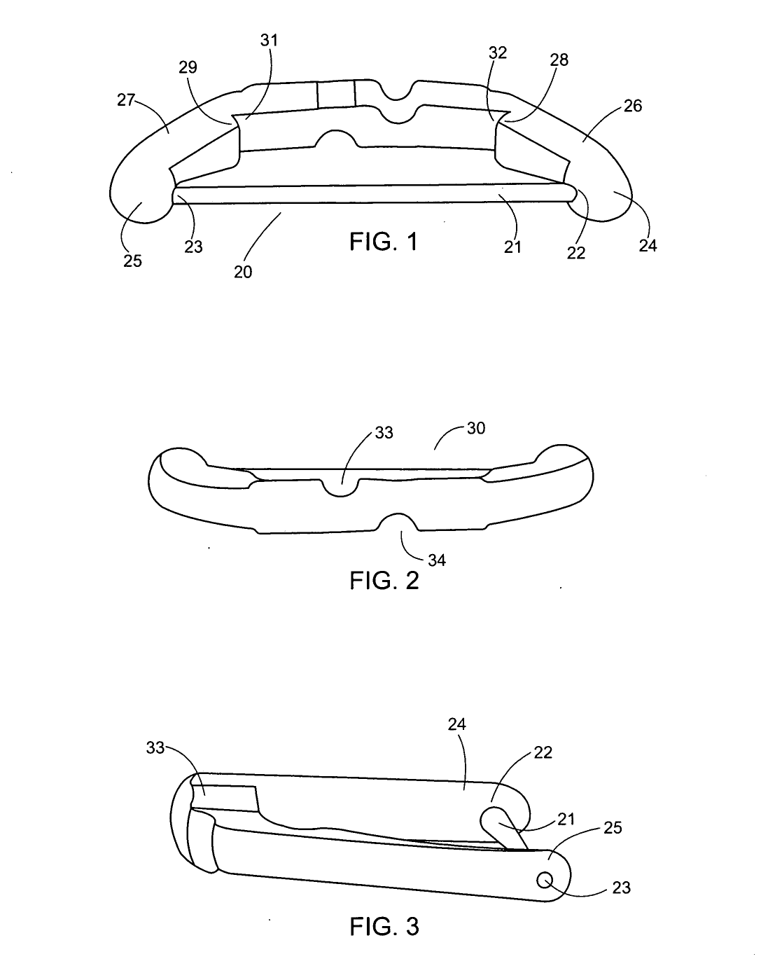

As seen in FIGS. 1-3, the flossing head 20 can have a pair of indentations that are opposed, but without corresponding protrusions. The flossing head 20 can insert into the receiving socket that is formed by the groove first indentation 44 and the groove second indentation 45. The flossing head 20 can also have an angled first retaining arm protrusion 28 and an angled second retaining on protrusion 29. The floss can be a dental tape or a round cross-section dental floss.

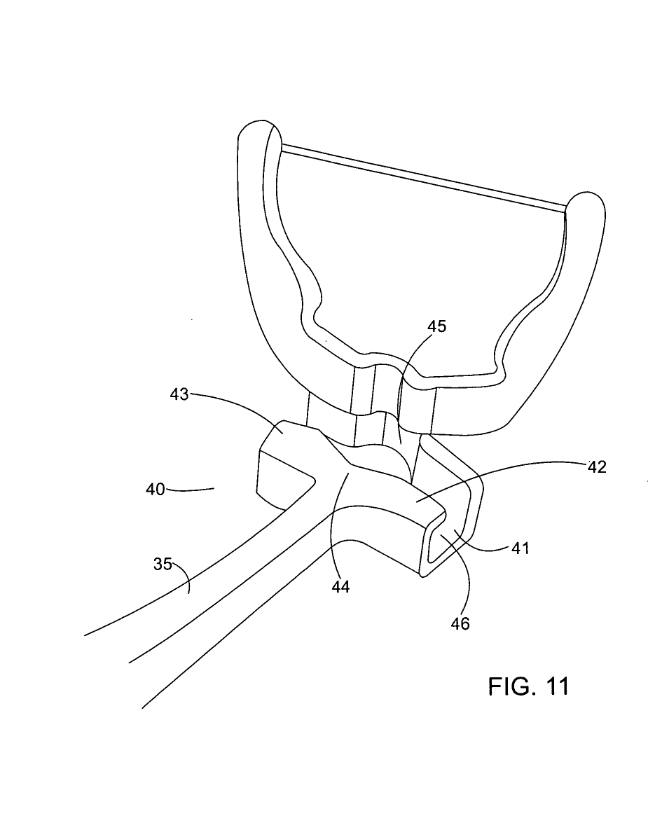

FIGS. 1-3 show a perspective view of the flossing head. The first flossing connection 22 is attached to the first retaining arm connection 24. The flossing head handle has a tapered profile that narrows toward a neck. The neck supports the flossing head retainer 40. The flossing head retainer preferably has a flossing head retainer groove 41 formed from resilient plastic material. The flossing head 20 fits within the flossing head retainer groove 41. The flossing head retainer groove 41 has an open side shown in FIG. 10 as a top opening. The flossing head retainer groove 41 also has a pair of sidewalls that retain the flossing had 20 within the flossing head retainer groove 41. The inside sidewall 47 is proximate to the handle and opposes the outside sidewall 48 distal to the handle. A lower wall 49 extends between the inside sidewall 47 and the outside sidewall 48. The inside sidewall 47 extends to a first retaining flange 42 and a second retaining flange 43. Optionally, the retaining flange can be separated into a first retaining flange 42 and a second retaining flange 43.

The flossing head retainer 40 has a flossing head retainer groove 41 that includes a socket having a wider portion for receiving various protrusions of the flossing head retainer 40. The socket wider portion is preferably configured to receive a variety of different flossing head retainers 40. Having a generous wider portion provides a compatibility with a variety of different flossing head retainers 40. The wider portion of the socket is defined between the groove first indentation 40 and the groove second indentation 45.

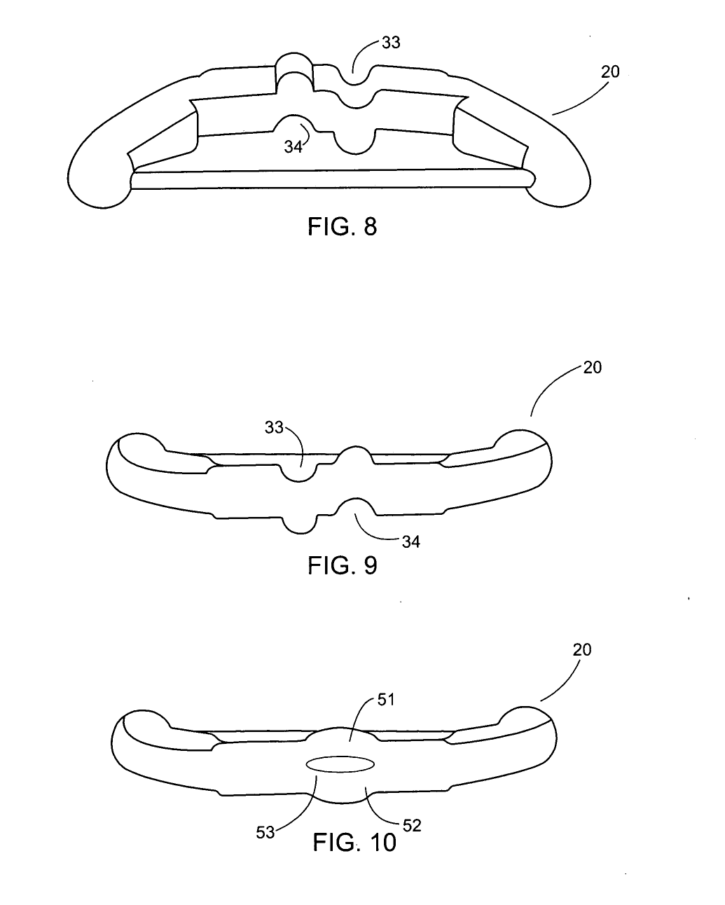

FIGS. 7-8 shows a second embodiment flossing head of a different configuration that has a pair of indentations and a pair of protrusions on different sides of the flossing head. The second embodiment flossing head can be made with or without protrusions or indentations.

FIG. 9 shows a best mode of the present invention flossing head 20 with a flexible opening 53 defined between a first flossing head protrusion 51 and a second flossing had protrusion 52. The first flossing head protrusion 51 and the second flossing head protrusion 52 act as leaf springs such that biasing the first flossing head protrusion 51 or the second flossing had protrusion 52 would narrow and open the flexible opening 53. The flexible opening 53 can be narrowed to a closed position during installation of the flossing head 20 into the flossing head retainer groove 41. The flossing head protrusion is optionally configured to fit at least partially under the groove overhang 46 such that the groove overhang 46 retains at least a portion of the flossing head protrusion. The first arm retaining notch 31 and the second arm retaining notch 32 cooperate with the first retaining arm protrusion 28 and the second retaining arm protrusion 29 to engage the left and right edges of the lower wall 49, preferably in a releasable snap fit engagement.

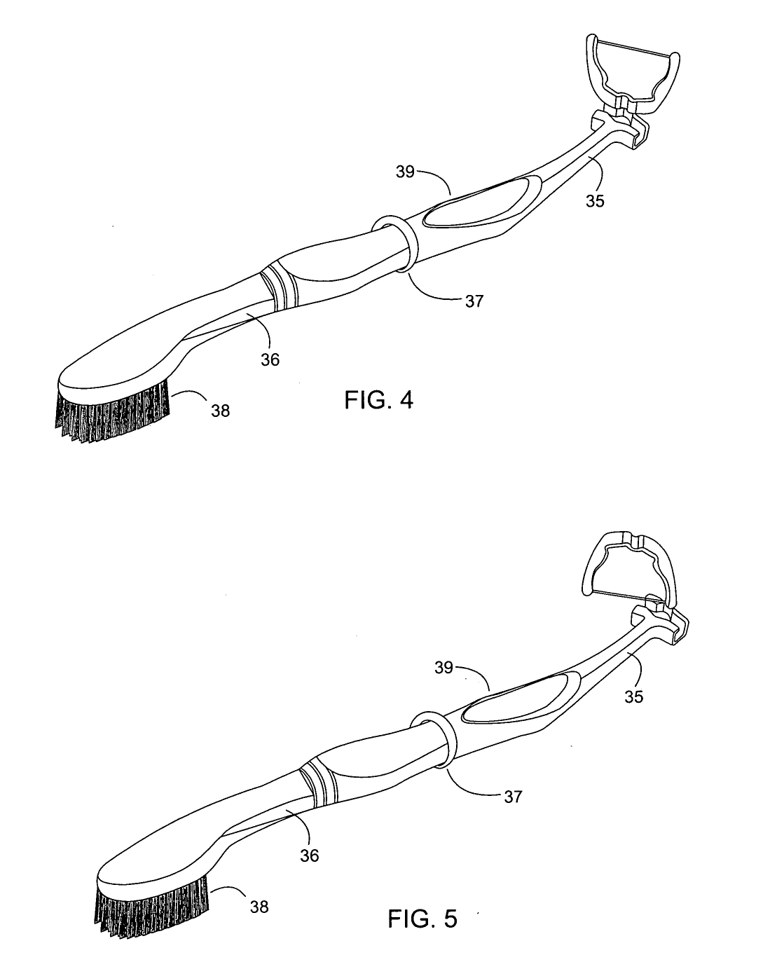

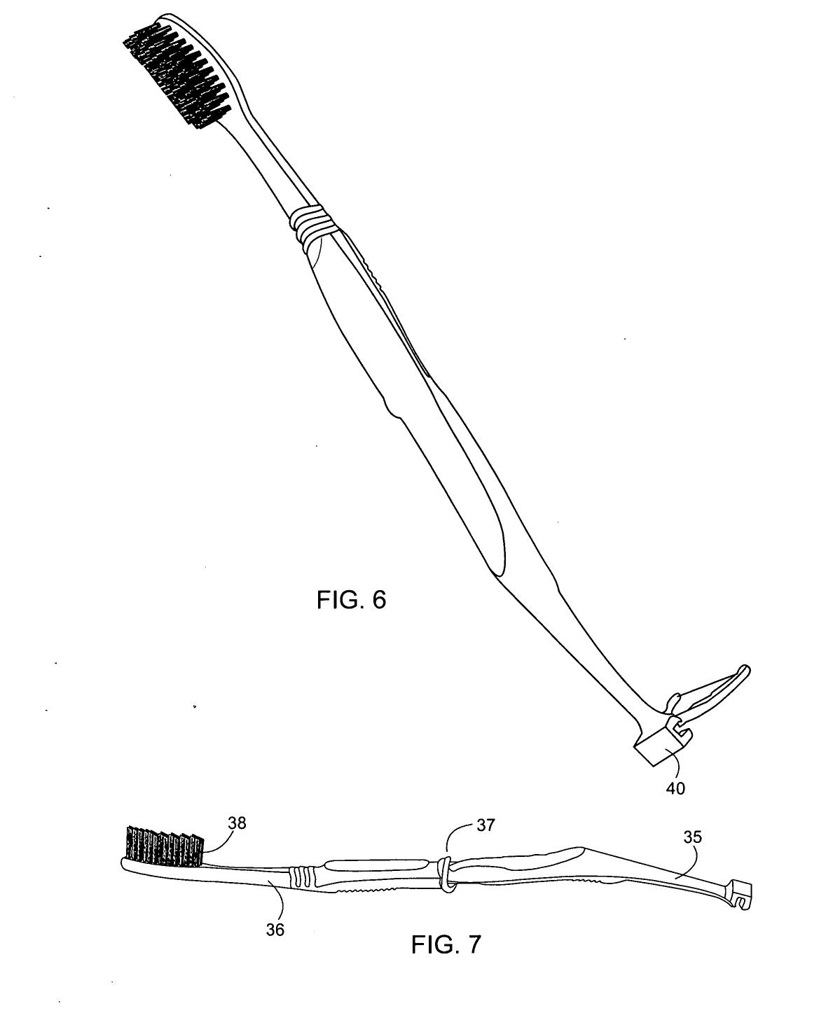

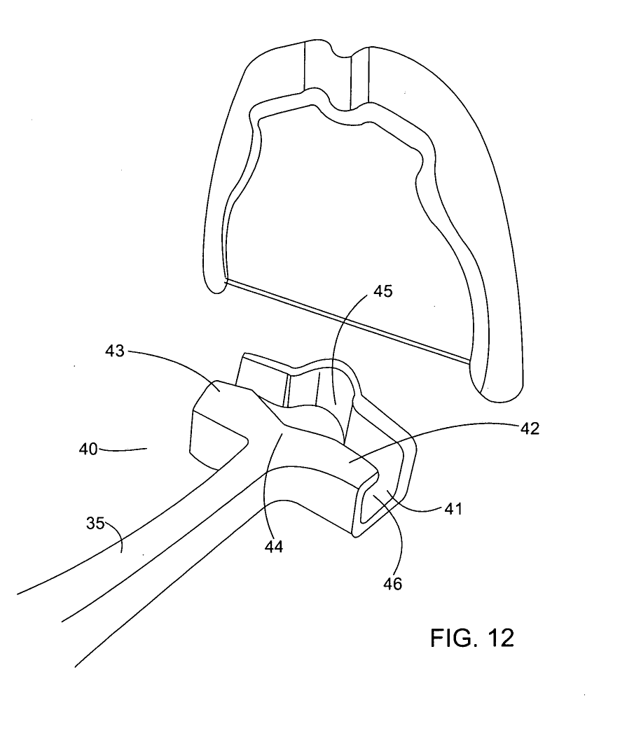

The socket of the flossing head retainer 40 preferably has 180° symmetry with regard to the orientation of the flossing head 20. The flossing head 40 can be inserted in a first position as shown in FIG. 4 where the groove resists pushing of the floss or alternatively in a second position as seen in FIG. 5 for the groove resists pulling of the floss. FIG. 11 shows a detail exploded perspective view of a flossing head connecting to a toothbrush flossing handle showing the first position of the flossing head. The first position has the groove facing the user and the second position as seen in FIG. 12 has the groove facing away from the user.

The socket of the flossing head retainer 40 not only allows reversibility of a flossing head 20, but also accommodates a wide variety of different types of flossing heads.

Obvious modifications from the specification can be made by persons of ordinary skill in the art without departing from the scope of the invention as defined in the following claims. For example, the flossing head can have a variety of different flavor or medicinal properties.

1-16. (canceled)

17. A toothbrush flosser comprising:
a. a handle having a pair of ends, namely a flossing head end and a brush head end;
b. a toothbrush head mounted to the brush head end, wherein the toothbrush head includes bristles;
c. a flossing head retainer mounted on the flossing head end;
d. a flossing head retained to the flossing head retainer at a connection area on the flossing head, wherein the flossing head has a pair of arms that hold a floss, wherein the pair of arms of the flossing head includes a first flossing head arm having a first retaining arm notch and second flossing head arm having a second retaining arm notch, wherein the first retaining arm notch has an inward orientation opposing the second retaining arm notch, wherein the second retaining arm notch has an inward orientation and opposing the first retaining arm notch, wherein the first retaining arm notch and the second retaining arm notch are both configured to allow the connection area to engage the flossing head retainer;
e. a flossing head retainer groove formed on the flossing head retainer to receive the connection area, wherein the flossing head retainer groove has an inside sidewall, an outside sidewall opposing the inside sidewall; and a lower wall, wherein the flossing head retainer groove has a wider portion that forms a socket, wherein the socket has reversible engagement with the flossing head, wherein the flossing head retainer groove has a retaining flange oriented parallel to the flossing head retainer groove, which is also parallel to the floss, wherein the retaining flange has a first retaining flange section and a second retaining flange section that overhang the retainer groove at a groove overhang oriented parallel to the flossing head, wherein the flossing head retainer groove with a first retaining flange section and a second retaining flange create the groove overhang for retaining the flossing head.
